(19) United States
(12) Patent Application Publication
(10) Pub. No.: US 2014/0113558 A1
(43) Pub. Date: Apr. 24, 2014

(54) PROXIMITY DETECTION USING AN ELECTRONIC DEVICE

(71) Applicant: APPLE INC., Cupertino, CA (US)

(72) Inventors: Devrim Varoglu, Santa Clara, CA (US); Gencer Cili, Santa Clara, CA (US)

(73) Assignee: APPLE INC., Cupertino, CA (US)

(21) Appl. No.: 13/657,606

(22) Filed: Oct. 22, 2012

(51) Int. Cl. H04B 7/24

(52) U.S. Cl. 455/41.2

(57) ABSTRACT

A method and system are described for proximity detection performed at an electronic device. In the described embodiments, an application is executing on the electronic device. The electronic device determines a target wireless signal strength based on a target distance. The electronic device receives a Bluetooth low energy (BLE) wireless signal from a second electronic device and generates a received wireless signal strength based on the received BLE wireless signal. The electronic device then compares the received wireless signal strength to the target wireless signal strength and on the condition that the received wireless signal strength exceed the target wireless signal strength, the electronic device performs one or more operations wherein the one or more operations include restricting a functionality of the application.

### BACKGROUND

1. Field

The described embodiments relate to proximity detection using an electronic device. More specifically, the described embodiments relate to performing one or more operations on the electronic device based on proximity detection.

2. Related Art

Often, users of an electronic device, such as a computer or a smartphone, desire to limit or otherwise alter the behavior or functionality of their electronic device based on circumstances, such as who is using the device, where the user is located, and/or what the user is doing. For example, a user may desire to limit the functionality of their smartphone while driving, but not while being a passenger in the car. Additionally, a user may desire to limit the web-browsing capabilities of a computer depending on who the user is, for example, by restricting browsing capabilities for a child by using a parental control filter. Although a user could manually configure their electronic device whenever each of these situations arises, the user must not only remember, but must also undertake the time and effort to do so. This may reduce the desirability and therefore utility of such restrictions, and inhibit users from actually undertaking the effort to use them.

### BRIEF DESCRIPTION OF THE FIGURES

FIG. 1 presents a block diagram illustrating an electronic device in accordance with described embodiments.

FIG. 2 presents a block diagram illustrating an operating system, applications and subsystems of an electronic device in accordance with described embodiments.

FIG. 3 presents a block diagram illustrating a transmitter with a target distance demarcation in accordance with described embodiments.

FIG. 4 presents a flowchart illustrating a process for performing operations on an electronic device based on proximity detection in accordance with described embodiments.

FIG. 5 presents a block diagram illustrating a transmitter transmitting a wireless signal, a location within the target distance, and a location outside the target distance in accordance with described embodiments.

FIG. 6 presents a chart depicting an exemplary relationship between a received wireless signal strength, received signal strength indicator (RSSI) and the distance of the receiver from the transmitter in accordance with described embodiments.

FIG. 7 presents a block diagram illustrating a transmitter transmitting a wireless signal with two target distances and three locations in accordance with described embodiments.

FIG. 8 presents a flowchart illustrating a process for performing operations on an electronic device based on proximity detection and identifiers associated with one or more transmitters in accordance with described embodiments.

FIG. 9 presents a block diagram illustrating two transmitters, each with a different target distance and a location within the target distance of each transmitter, in accordance with described embodiments.

FIG. 10 presents a block diagram illustrating an exemplary configuration including a Bluetooth low energy (BLE) transmitter and two smartphones arranged in a configuration similar to FIG. 9 in accordance with described embodiments.

In the figures, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by an electronic device with computing capabilities. For example, the computer-readable storage medium can include volatile memory or non-volatile memory, including flash memory, random access memory (RAM, SRAM, DRAM, RDRAM, DDR/DDR2/DDR3 SDRAM, etc.), magnetic or optical storage mediums (e.g., disk drives, magnetic tape, CDs, DVDs), or other mediums capable of storing data structures or code. Note that, in the described embodiments, the computer-readable storage medium does not include non-statutory computer-readable storage mediums such as transmission signals.

The methods and processes described in this detailed description can be included in hardware modules. For example, the hardware modules can include, but are not limited to one or more application-specific integrated circuit (ASIC) chips, field-programmable gate arrays (FPGAs), other programmable-logic devices, dedicated logic devices, and microcontrollers. When the hardware modules are activated, the hardware modules perform the methods and processes included within the hardware modules. In some embodiments, the hardware modules include one or more general-purpose circuits that are configured by executing instructions (program code, firmware, etc.) to perform the methods and processes.

The methods and processes described in the detailed description section can be embodied as code and/or data that can be stored in a computer-readable storage medium as described above. When a device (e.g., an electronic device or fixed display system) with computing capabilities reads and executes the code and/or data stored on the computer-readable storage medium, the device performs the methods and processes embodied as data structures and code and stored within the computer-readable storage medium. For example, in some embodiments, a processing subsystem can read the code and/or data from a memory subsystem that comprises a computer-readable storage medium and can execute code and/or use the data to perform the methods and processes.

In the following description, we refer to “some embodiments.” Note that “some embodiments” describes a subset of all of the possible embodiments, but does not always specify the same subset of embodiments.

### Overview

Described embodiments perform operations for proximity detection using an electronic device and perform one or more operations on the electronic device based on the results of the proximity detection. In some embodiments, the proximity detection can be described as being used to set up proximity fencing as described below. In described embodiments, the electronic device can include any electronic device that can receive a wireless signal, convert the wireless signal to a received wireless signal strength, and based on the relationship between the received wireless signal strength and a target wireless signal strength, perform one or more operations. An electronic device can include, but is not limited to, a server, a desktop computer, a laptop computer, a netbook, a tablet computer, a smartphone, or any system that includes a receiver and processing subsystem such as a car, a television, or a desktop phone. The wireless signal may be transmitted from any source, including, but not limited to, another electronic device, which may be or include a dedicated transmitter such as a Bluetooth low energy (BLE) key fob or other special purpose-built transmitter.

During operation, a target distance is converted into a target wireless signal strength. The target distance may be converted into one or more target wireless signal strengths based on the type of wireless signal(s) that can be received by the electronic device. For example, the electronic device may receive a Bluetooth wireless signal, a BLE signal, an infrared signal and/or any other type of wireless signal.

The target distance may be entered into an electronic device using any desired method, such as entering it directly into the electronic device or into another device and transmitting it to the electronic device, or a user may hold or position the electronic device at the target distance from a wireless transmitter. Additionally, the target distance may be entered in any desired distance units, such as feet, meters, inches, or centimeters.

In some embodiments, the target distance is converted into a target wireless signal strength based on a predetermined relationship between distance and signal strength for each type of wireless signal. The predetermined relationship may be determined using any desired method including, but not limited to, calibration testing of data programmed into the electronic device during or after its manufacture, and/or data gathered by the user of the electronic device, for example in the same or a similar configuration as the desired usage. In some embodiments, the target distance may be entered by the user by holding or positioning the electronic device at the desired target distance from a wireless signal transmitter, and the target distance is converted into a target wireless signal strength by measuring the signal strength from the transmitter on the electronic device while it is at the target distance.

The user may also enter one or more operations for the electronic device to perform when it detects a wireless signal strength greater than or equal to the target wireless signal strength. For example, a user may desire to restrict the functionality of an electronic device such a smartphone while the user is driving. A dedicated transmitter such as a BLE transmitter may be placed on or near the steering wheel of the user's car and the target distance set (e.g., to a few feet). The target distance is then converted to a target wireless signal strength. The user may then set the smartphone so that when it is within the target distance of the BLE transmitter (e.g., the received wireless signal strength is greater than the target wireless signal strength), voice command features are enabled and some calling features are disabled.

Then, when the user enters the car with their smartphone, the smartphone will detect the signal from the BLE transmitter, and when the received wireless signal strength from the BLE transmitter exceeds the target signal strength, the smartphone will take the desired action (e.g., enable voice command features and disable calling features). In some embodiments, the target wireless signal strength can be thought of as setting up proximity fencing around the BLE transmitter for the electronic device. When the smartphone enters the proximity fencing around the transmitter, (i.e., the received wireless signal strength from the BLE transmitter exceeds the target signal strength), the smartphone takes the desired action.

In some embodiments, the desired action may include restricting one or more functionalities of one or more applications. Restricting a functionality of an application may include but is not limited to disabling, limiting or otherwise inhibiting input modes (such as disabling a keyboard, touch screen and/or other non-voice input modes) and/or output modes (such as disabling the generation of alert tones or tactile sensations (e.g., vibration) for telephony or messaging applications for incoming telephone calls, text messages, multimedia messages, and/or email messages). Other examples of restricting a functionality may include implementing parental control restrictions (e.g., for Internet browsing or for listening to or viewing media content), and/or password protecting an application or features of an application.

In some embodiments, a wireless signal may include an identifier, such as a universally unique identifier (UUID), encoded in the signal that is associated with the transmitter. In these embodiments, the user may associate each identifier with a target distance and a set of one or more operations to be performed on the electronic device. For example, one BLE transmitter with a first identifier may be placed on a car steering wheel as described above. The target distance may be set to 2 feet and the electronic device may be set to allow the smartphone to be used only with voice command features when it is within the target distance from this BLE transmitter. A second BLE transmitter with a second identifier may be attached to a child seat in the car and the target distance for this BLE transmitter set to 18 inches with the electronic device set to enable safe-browsing and gaming restrictions on the electronic device when it is within the target distance of the BLE transmitter on the child seat. A third BLE transmitter with a third identifier may be affixed near the user's bed and the target distance set to 5 feet with the electronic device set to deactivate or limit sound queues (e.g., ringtones or message queues from certain incoming calls).

In some embodiments, more than one target distance and set of operations may be associated with each of one or more transmitters. Additionally, the electronic device may be configured to use information in addition to the received wireless signal strength(s) and identifier(s) to determine which operations to perform. For example, a user may set the electronic device to allow only voice commands when it is within the target distance from a BLE transmitter attached to the steering wheel of the car and the car is in motion. The motion of the car may be sensed using any desired method, such as detecting a Doppler shift of a signal from a cellular tower transmission, using the global positioning system, or any other system for detecting position, velocity, and/or acceleration. In another example, when a user sets the electronic device to deactivate certain sound queues when it is within the target distance from a BLE transmitter affixed near the user's bed, the user may also set the electronic device to only deactivate the sounds when it is between certain hours at night (e.g., 10 PM and 6 AM) and/or the electronic device has not yet been moved in the morning. Note that any set of additional inputs may be used, in conjunction with the received wireless signal strength, including information received through a connection to the Internet (such as weather or traffic information) or a local area network (e.g., a Wi-Fi connection).

In some embodiments, a second electronic device may serve as the transmitter of the wireless signal. For example, a user may place a first BLE transmitter on the steering wheel in a car as described above and associate that identifier with a set of actions on the user's smartphone as described above. The user may also set a target distance to a transmitter (such as a Bluetooth transmitter) in a second smartphone (such as a family member's smartphone) to 10 feet and set the user's smartphone to forward calls from family and friends to the family member's smartphone while he is within the target distance of the steering wheel BLE transmitter, the car is in motion, and the family member's smartphone is within the second target distance.

### Electronic Device

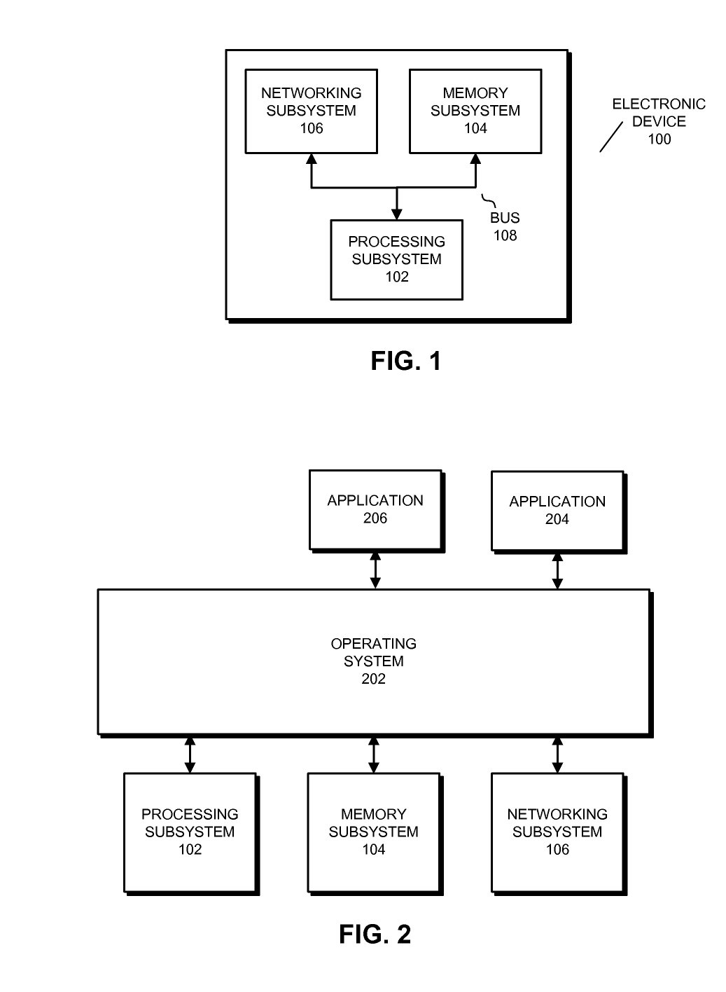

FIG. 1 presents a block diagram illustrating electronic device 100 in accordance with described embodiments. Electronic device 100 includes processing subsystem 102, memory subsystem 104, and networking subsystem 106 all coupled together and communicating through bus 108.

Processing subsystem 102 includes one or more devices configured to perform computational operations. For example, processing subsystem 102 can include one or more microprocessors, application-specific integrated circuits (ASICs), microcontrollers, and/or programmable-logic devices.

Memory subsystem 104 includes one or more devices for storing data and/or instructions for processing subsystem 102, and networking subsystem 106. For example, memory subsystem 104 can include any type of computer-readable storage medium such as dynamic random access memory (DRAM), static random access memory (SRAM), and/or other types of memory. In addition, memory subsystem 104 can include mechanisms for controlling access to the memory. In some embodiments, memory subsystem 104 includes a memory hierarchy that comprises one or more caches coupled to a memory in electronic device 100. In some of these embodiments, one or more of the caches is located in processing subsystem 102.

In some embodiments, memory subsystem 104 is coupled to one or more high-capacity mass-storage devices (not shown). For example, memory subsystem 104 can be coupled to a magnetic or optical drive, a solid-state drive, or another type of mass-storage device. In these embodiments, memory subsystem 104 can be used by electronic device 100 as fast-access storage for often-used data, while the mass-storage device is used to store less frequently used data.

Networking subsystem 106 includes one or more devices configured to couple to and communicate on a wired and/or wireless network (i.e., to perform network operations). For example, networking subsystem 106 can include a Bluetooth networking system (which may include Bluetooth low energy (BLE) capabilities), a cellular networking system (e.g., a 3G/4G network such as UMTS, LTE, etc.), a universal serial bus (USB) networking system, a networking system based on the standards described in IEEE 802.11 (such as a Wi-Fi networking system), an Ethernet networking system, and/or another networking system. Networking subsystem 106 includes processors, controllers, radios/antennas, sockets/plugs, and/or other devices used for coupling to, communicating on, and handling data and events for each supported networking system.

Processing subsystem 102, memory subsystem 104, and networking subsystem 106 are coupled together using bus 108. Bus 108 is an electrical, optical, or electro-optical connection that the subsystems can use to communicate commands and data among one another. Although only one bus 108 is shown for clarity, different embodiments can include a different number or configuration of electrical, optical, or electro-optical connections among the subsystems.

Although shown as separate subsystems in FIG. 1, in some embodiments, some or all of a given subsystem can be integrated into one or more of the other subsystems in electronic device 100. Although alternative embodiments can be configured in this way, for clarity we describe the subsystems separately.

Electronic device 100 can be (or can be included in) any device with at least one processing subsystem and one networking subsystem. For example, electronic device 100 can be (or can be included in) a laptop computer, a media player, a subnotebook/netbook, a tablet computer, a cellular phone, a personal digital assistant (PDA), a smartphone, a toy, a controller, a key fob, or another device. Electronic device 100 may also be included in any system or structure such as a car, a house, or a kitchen appliance

Electronic device 100 may also include one or more additional processing subsystems 102, memory subsystems 104, and/or networking subsystems 106. Additionally, one or more of the subsystems may not be present in electronic device 100. Furthermore, although we use specific subsystems to describe electronic device 100, in alternative embodiments, electronic device 100 may include one or more additional subsystems that are not shown in FIG. 1. For example, electronic device 100 may also include, without limitation, a data collection subsystem, an alarm subsystem, an audio subsystem, a display subsystem and/or an input/output (I/O) subsystem. For example, electronic device 100 may include a display subsystem which can include any type of display technology such as light emitting diode (LED), organic light emitting diode (OLED), liquid crystal display (LCD) (such as thin film transistor (TFT), and/or other types of display technology. In addition, the display subsystem may include mechanisms for processing data, and/or other information for display and may also include an audio subsystem for producing sound. The display subsystem may also include touch screen technology for inputting information into electronic device 100. In some embodiments, one or more memory caches and/or processing systems or other hardware modules may be located in the display subsystem.

### Operating System

FIG. 2 presents a block diagram illustrating operating system 202 in accordance with the described embodiments. In some embodiments, operating system 202 is stored (as program code) in memory subsystem 104 and executed by processing subsystem 102.

Generally, operating system 202 serves as an intermediary between system hardware in electronic device 100 (e.g., subsystems 102-106) and applications executed by processing subsystem 102, such as applications 204-206 (which can be, for example, an email application, a web browser, a text messaging application (for communicating Short Message Service (SMS) messages and/or other types of text messages), a voice communication application, and/or a game application). For example, operating system 202 can be, but is not limited to, the iOS operating system or OS X operating system, both from Apple Inc. of Cupertino, Calif.; Windows Phone from Microsoft Corporation; Android from the Open Handset Alliance; the FreeBSD operating system from The FreeBSD Foundation of Boulder, Colo.; or another operating system. Operating systems and their general functions are known in the art and hence are not described in detail.

To manage the transfer of packets to and from applications 204-206 and operating system 202 in electronic device 100 using an appropriate interface in networking subsystem 106, operating system 202 maintains one or more network protocol stacks (not shown) that each includes a number of logical layers. For example, the operating system can maintain a Bluetooth protocol stack and/or an Internet protocol stack, which includes the link, Internet, transport, and application layers. As another example, the operating system can maintain a protocol stack based on the OSI model, which includes the application, presentation, session, transport, network, data-link, and physical layers. At corresponding layers of the protocol stack, the operating system includes control mechanisms and data structures for performing the functions associated with the layer. The functions associated with each of the layers in the protocol stack are known in the art and hence are not described in detail.

### Target Distance

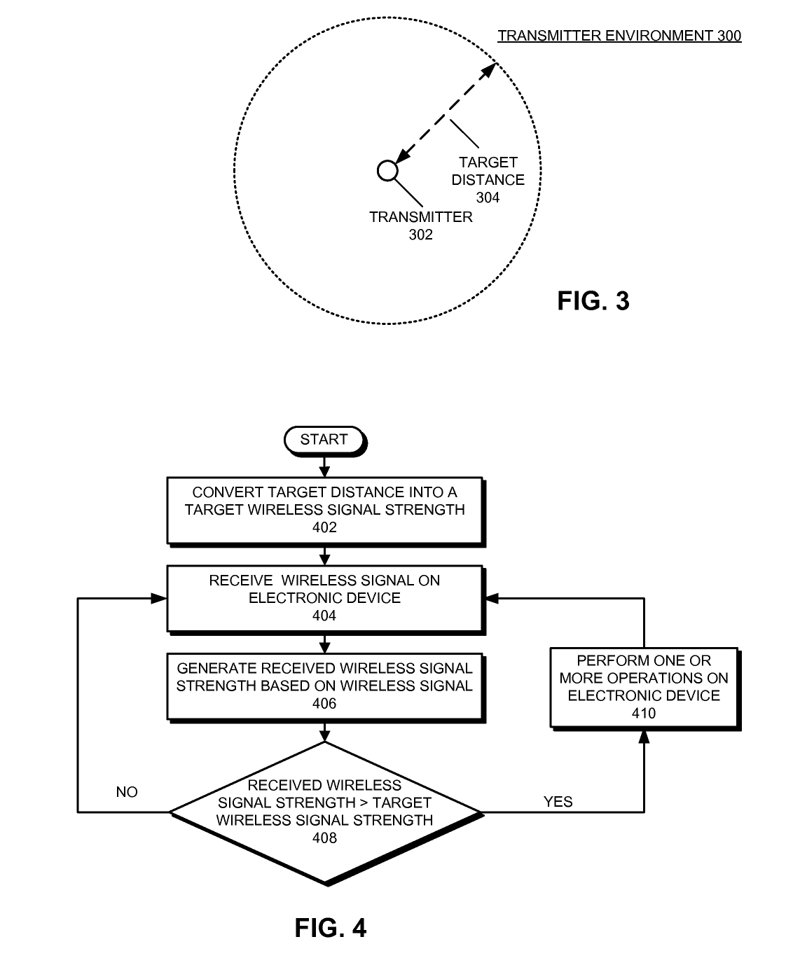

FIG. 3 presents a block diagram illustrating a transmitter with a target distance demarcation in accordance with described embodiments. Transmitter environment 300 includes transmitter 302 and target distance 304 delineated by a circle about transmitter 302. Transmitter 302 can be any transmitter that can transmit a wireless signal that can be received by electronic device 100. Transmitter 302 may include, but is not limited to, a transmitter that transmits a wireless signal using Bluetooth technology, cellular telephone technology such as a low-power cellular base station (e.g., a femtocell), or ZigBee technology.

Target distance 304 can be any target distance measured or signified in any way using any input method. For example, a user may enter target distance 304 into electronic device 100 using a data input subsystem of electronic device 100, such as a keyboard, keypad, or touch screen. Additionally, a target distance may be entered by positioning electronic device 100 at the target distance from transmitter 302. Note that in some embodiments, the circle about transmitter 302 delineated by target distance 304 may be thought of as a proximity fence.

### Performing Operations Based on Proximity Detection

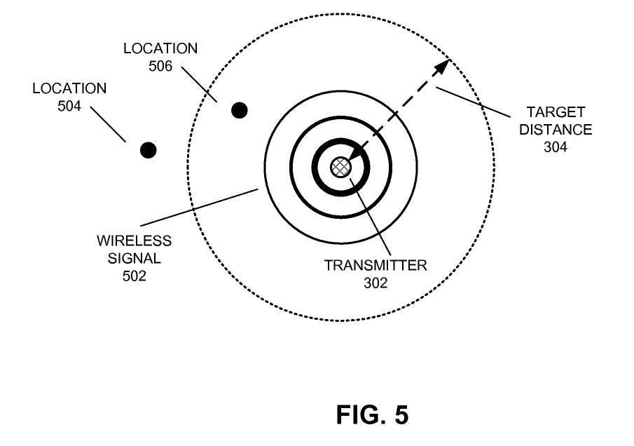

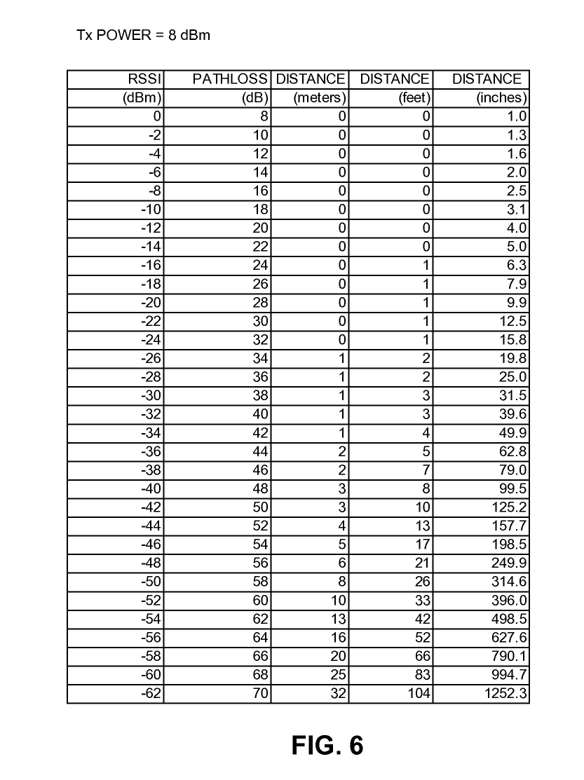

FIG. 4 presents a flowchart illustrating a process for performing operations on an electronic device based on proximity detection in accordance with described embodiments. The operations shown in FIG. 4 may be performed by an electronic device, such as electronic device 100. The process displayed in FIG. 4 will be discussed with reference to FIGS. 5 and 6 below.

FIG. 5 illustrates a network transmitter environment similar to transmitter environment 300, in which transmitter 302 is transmitting wireless signal 502, and two locations are marked. Location 504 is farther from transmitter 302 than target distance 304, while location 506 is closer to transmitter 302 than target distance 304.

The process of FIG. 4 may begin when electronic device 100 converts the target distance into a target wireless signal strength (step 402). The target distance can be converted into a target wireless signal strength using any desired process including, but not limited to, a lookup table, a direct measurement of the wireless signal strength at the target distance, or a formula. The target wireless signal strength may be generated for any type of wireless signal that electronic device 100 can receive. For example, if networking subsystem 106 in electronic device 100 includes networking systems for BLE and ZigBee, then the target wireless signal strength may be determined for both BLE and ZigBee.

FIG. 6 depicts a sample lookup table that may be used to determine a target wireless signal strength based on a target distance. In the exemplary lookup table of FIG. 6, the target wireless signal strength may be represented by the received signal strength indicator (RSSI) in the first column, and the target distance in meters, feet, or inches are in the last three columns. A target distance can then be used to determine the RSSI and hence the target wireless signal strength.

Referring back to FIG. 4, we note that step 402 need not occur on electronic device 100. For example, the target distance may be converted into a target wireless signal strength on a second electronic device or other device (such as a server that stores the lookup tables) and then transferred to electronic device 100 via any desired mechanism, such as a wired connection, a wireless connection, a memory stick.

Note that the target distance may be generated or entered using any desired method. The target distance may be directly entered into electronic device 100 using a keyboard, keypad, touch screen, or voice recognition, loaded from a file stored on electronic device 100, or programmed into a memory or other circuit in electronic device 100. Additionally, the target distance may be loaded through a wired or wireless connection such as a Bluetooth connection or a network connection to a local area network (LAN) or wide area network (WAN) such as the Internet. For example, the target distance or target wireless signal strength may be transmitted to electronic device 100 from transmitter 302.

At step 404 electronic device 100 receives a wireless signal from transmitter 302. Referring to FIG. 5, transmitter 302 transmits wireless signal 502. Electronic device 100 receives wireless signal 502 (step 404) using networking subsystem 106. For example, if transmitter 302 is a BLE device and wireless signal 502 is a BLE signal, then networking subsystem 106 would use its BLE system to receive the BLE wireless signal. Electronic device 100 then generates a received wireless signal strength based on the received wireless signal (step 406). For example, networking subsystem 106 may generate an RSSI based on the received wireless signal strength. The received wireless signal strength is then compared to the target wireless signal strength (step 408).

This comparison may occur in electronic device 100 using processing subsystem 102. The target wireless signal strength may be stored in memory subsystem 104 and the received wireless signal strength may be generated from the received wireless signal in networking subsystem 106. Processing subsystem 102 may then retrieve the target wireless signal strength from memory subsystem 104 via bus 108 and retrieve the received wireless signal strength from networking subsystem 106 via bus 108. Processing subsystem 102 then compares the received wireless signal strength to the target wireless signal strength.

If the received wireless signal strength is not greater than the target wireless signal strength (step 408), then the process returns to step 404. If the received wireless signal strength is greater than the target wireless signal strength at step 408, then the process continues to step 410. At step 410, electronic device 100 performs one or more operations and returns to step 404. The operations performed at step 410 may be operations selected by a user of electronic device 100 to be performed when it is within the target distance from transmitter 302 as determined based on the received signal strength being greater than the target signal strength. The operations performed at step 410 may also be pre-programmed into electronic device 100, downloaded or received from another source (e.g., through a network connection), or based on other sensing and/or one or more states of electronic device 100. For example, in some embodiments, when a user inputs the target distance, the user may also enter one or more operations for electronic device 100 to perform when the condition in step 408 is met. In some embodiments, a user may enter one or more operations to be performed while the condition of step 408 is not met, before the process returns to step 404. Examples of operations that could be performed at step 410 include, but are not limited to restricting one or more functionalities of one or more applications operating on electronic device 100 such as disabling, limiting, or otherwise inhibiting input modes (such as disabling a keyboard, touch screen and/or other non-voice input modes) and/or output modes (such as disabling or otherwise inhibiting the generation of alert tones or tactile sensations (e.g., vibration) for incoming telephone calls, text messages, multimedia messages, and/or email messages). Other examples of restricting a functionality may include implementing parental control restrictions (e.g., safe-browsing filters for Internet browsing, or ratings limits for listening to or viewing media content), and/or password protecting an application or features of an application. Additional examples of operations that could be performed at step 410 include removing restrictions on a functionality and/or altering or increasing one or more functionalities of one or more applications operating on electronic device 100.

Electronic device 100 may be configured to perform these operations using an application (such as application 204) operating on processing subsystem 102 that allows a user to select the one or more operations performed in step 410. Then, when the condition in step 408 is met, the application may communicate with operating system 202 operating on processing subsystem 102 to perform the one or more operations. Then, after step 410, the process returns to step 404.

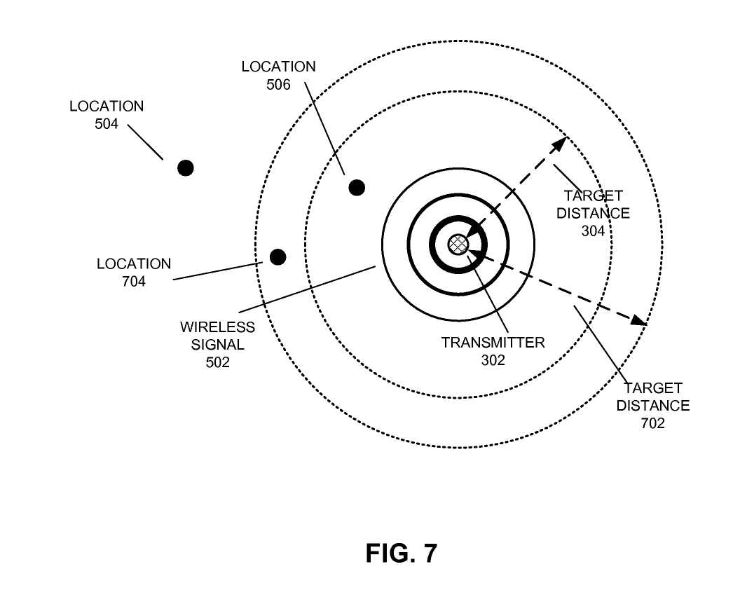

FIG. 7 depicts another target distance environment in accordance with disclosed embodiments. FIG. 7 includes target distance 702 and exemplary location 704 located in between target distance 304 and target distance 702. Electronic device 100 may implement a target distance environment using a process similar to that depicted in FIG. 4. In some embodiments, a second target distance may be generated or entered and converted into a second target wireless signal strength using methods similar to those used for the target distance described above. Then, at step 408, the received wireless signal strength is compared to the target wireless signal strength, as described above, and also the second wireless signal strength. If the received wireless signal strength is greater than the target wireless signal strength, then the one or more operations (step 410) are executed by electronic device 100. If the received wireless signal strength is greater than the second target wireless signal strength, then electronic device 100 performs a second set of operations. A user may determine and enter the operations in the second set of operations using a process similar to the process used to determine and enter the one or more operations performed in step 408. Note that a third set of operations may be determined and entered by a user for the situation in which the received wireless signal strength is greater than the second target wireless signal strength (e.g., as determined from target distance 702), but less than the (first) target wireless signal strength (e.g., as determined from target distance 304) (e.g., at location 704).

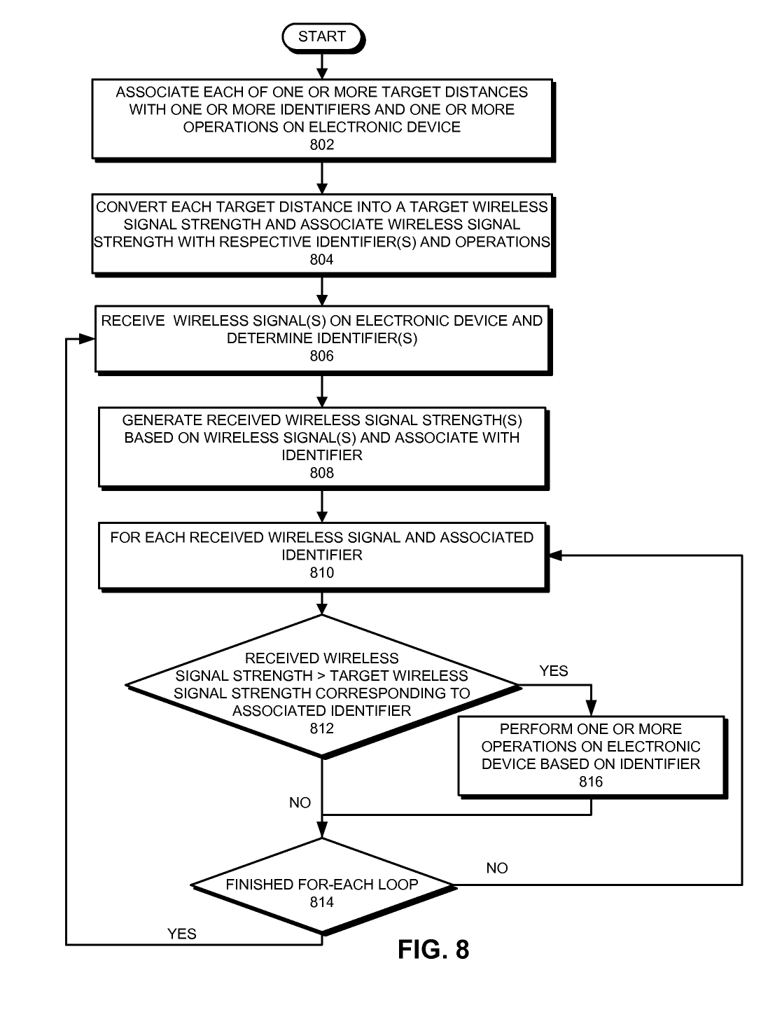

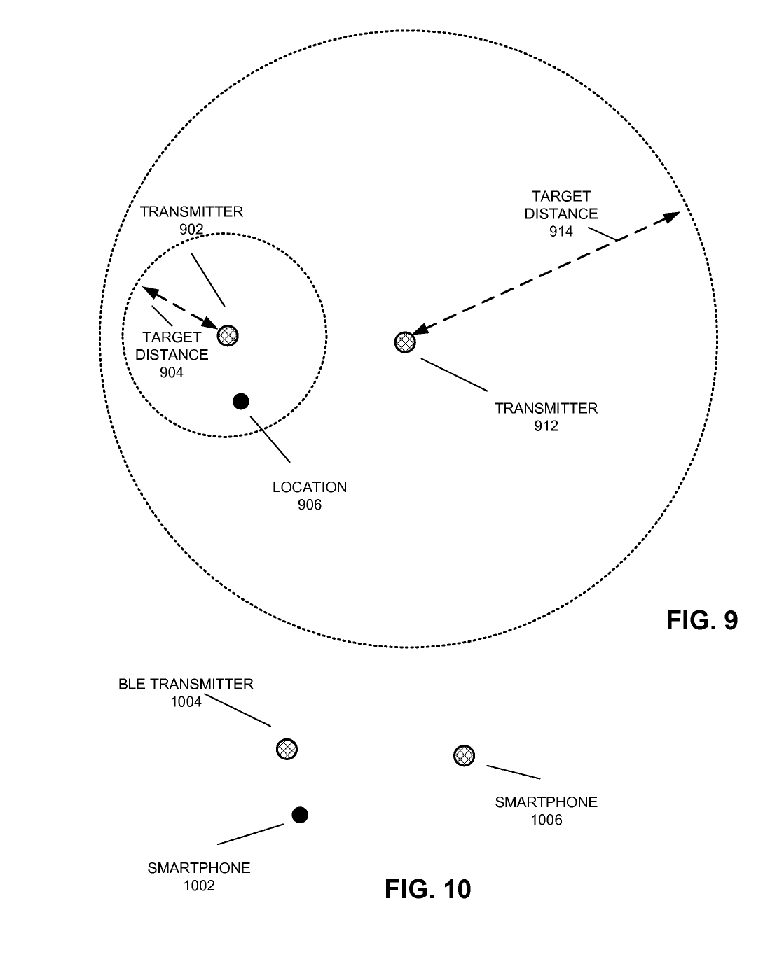

FIG. 8 presents a flowchart illustrating a process for performing operations on an electronic device based on proximity detection and identifiers associated with one or more transmitters in accordance with described embodiments. The operations shown in FIG. 8 are performed by an electronic device, such as electronic device 100, and some of the operations may be performed when electronic device 100 is operating near one or more transmitters. The process displayed in FIG. 8 will be discussed with reference to FIGS. 9 and 10 below.

FIG. 9 illustrates a transmitter environment in which transmitter 902 and transmitter 912 are transmitting wireless signals. Note that, for clarity, the wireless signals are not shown in FIG. 9. The process of FIG. 8 begins when each of one or more target distances is converted into a target wireless signal strength and associated with an identifier and one or more operations (step 802). Each target distance is converted into a target wireless signal strength as described above (step 804).

The target distances and associated identifiers and one or more operations may be generated or entered using any desired method, such as entering them directly into electronic device 100 using a keyboard, keypad, touch screen, or voice recognition; and/or loading them from a file stored on electronic device 100 or available through a wired or wireless connection such as a Bluetooth connection or a network connection to a local area network (LAN) or wide area network (WAN) such as the Internet. For example, one or more of the target distance, target wireless signal strength, associated identifier and one or more operations may be transmitted to electronic device 100 from transmitter 302. Note that electronic device 100 may include an application (e.g., application 206) that allows users to enter the one or more target distances, the associated identifiers and one or more operations.

In some embodiments, a user may hold electronic device 100 at the target distance from the desired transmitter and receive the wireless signal from the transmitter to select the target distance and/or target wireless signal strength and the associated identifier. Note that the wireless signal may include the identifier of the transmitter encoded in the wireless signal. For example, if the wireless signal is a BLE signal, the identifier used may be a universally unique identifier (UUID) for the BLE transmitter. The user may also use the application to associate the distance and identifier with the one or more operations using a list of available operations, such as preventing incoming calls, activating voice command, implementing do not disturb features, activating or deactivating alarms or other sound queues, or any other action.

At step 806, electronic device 100 receives one or more wireless signals using networking subsystem 106 and determines the identifier for each wireless signal (e.g., the UUID). For example, if electronic device 100 is located at location 906 in FIG. 9, then it might receive two wireless signals: one from transmitter 902 and one from transmitter 912. At step 808, electronic device 100 generates a received wireless signal strength for each received wireless signal based on the signal strength of the received wireless signal, and associates the received wireless signal strength with the identifier from the respective received wireless signal. The received wireless signal strength may be generated using methods described above, such as generating an RSSI for each received wireless signal.

Then, for each received wireless signal and associated identifier (step 810), electronic device 100 determines if the received wireless signal strength is greater than the target wireless signal strength corresponding to the associated identifier (step 812). If the received wireless signal strength is greater than the target signal strength for the corresponding identifier (e.g., within the proximity fencing established for the corresponding identifier), then the process proceeds to step 816 and electronic device 100 performs the one or more operations associated with the identifier. The process then continues to step 814. At step 814, if each received wireless signal and associated identifier has not been looped through, then the process returns to step 810; if each received wireless signal and associated identifier has been looped through, then the process returns to step 806.

FIG. 10 depicts an exemplary use of a transmitter environment similar to that depicted in FIG. 9, which may be a user's car as described below, in accordance with described embodiments. In FIG. 10 smartphone 1002 (i.e., an electronic device) is at location 906. Smartphone 1002 may be any smartphone that includes a networking subsystem such as networking subsystem 106. BLE transmitter 1004 may be a key fob BLE transmitter attached to the steering wheel in the user's car. Smartphone 1006 may also be any smartphone that includes a Bluetooth transmitter. Smartphone 1006 may be a smartphone carried by a family member of the user. Similarly to the transmitter environment of FIG. 9, the user may set the target distance for the identifier associated with BLE transmitter 1004 to distance 904, and the target distance associated with the identifier of smartphone 1006 to distance 914. Then, when the user enters the car and sits on the driver's side, smartphone 1002 will receive wireless signals from BLE transmitter 1004 and smartphone 1006, and using the process described in FIG. 8, determine at step 812 that smartphone 1002 is within distance 904 from BLE transmitter 1004 and within distance 914 from smartphone 1006.

The user may determine the operations for smartphone 1002 to perform as follows. If smartphone 1002 is within target distance 904 from BLE transmitter 1004, the user may have smartphone 1002 disable calling features and allow only voice command features since the position of smartphone 1002 implies that the user is sitting at the steering wheel of the car. Note that in some embodiments, voice command features on an electronic device such as smartphone 1002 allow a user to do what the user typically does with an application (e.g., place calls, send a text message, perform a search) using their voice. Additionally, when an electronic device such as smartphone 1002 is controlled to allow only voice command features for an application, as discussed above, then any non-voice input mode such as keyboard or touch screen inputs are disabled (and in some embodiment, voice command features may be enabled if they are not already enabled).

In some embodiments, the user may have smartphone 1002 perform other operation instead of or in addition to those described above. For example, the operations may include restricting the functionality of an application to inhibit any audible and/or tactile alerts (e.g., ringtones, text tone, and/or vibrating) for incoming telephone calls, text messages, multimedia messages, and/or email messages. The user may have smartphone 1002 only perform these operations if, in addition to being within target distance 904 of BLE transmitter 1004, smartphone 1002 determines that the car is moving by, for example, detecting a Doppler shift in a signal received from a cellular transmission tower. The user may also set smartphone 1002 to perform additional operations if it is not only within target distance 904 from BLE transmitter 1004 in a moving car, but also within target distance 914 of smartphone 1006. In such cases, the user may have smartphone 1002 forward all calls from family members to smartphone 1006, so that the family member in the car (e.g., the owner of smartphone 1006) can answer the phone calls for the user.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for proximity detection performed at an electronic device, the method comprising:
the electronic device executing an application;
the electronic device determining a target wireless signal strength based on a target distance;
the electronic device receiving a Bluetooth low energy (BLE) wireless signal from a second electronic device;
the electronic device generating a received wireless signal strength based on the received BLE wireless signal;
the electronic device comparing the received wireless signal strength to the target wireless signal strength; and
on condition that the received wireless signal strength exceeds the target wireless signal strength, the electronic device performing one or more operations, wherein the one or more operations include restricting a functionality of the application.

2. The method of claim 1, wherein the application is a telephony application and the restricting the functionality includes disabling one or more non-voice input modes for the application.

3. The method of claim 1, wherein performing the one or more operations further includes:
performing the one or more operations based on an identifier encoded in the wireless signal.

4. The method of claim 1, further including:
determining a second target wireless signal strength based on a second target distance;
comparing the received wireless signal strength to the second target wireless signal strength; and
performing one or more operations on the electronic device based on a result of the comparison between the received wireless signal strength and the second target wireless signal strength.

5. The method of claim 1, wherein the application is a text messaging application and the restricting the functionality includes inhibiting the text messaging application from generating an audible alert in response to receiving a message.

6. The method of claim 1, wherein the second electronic device includes a BLE transmitter, wherein the target distance is associated with a universally unique identifier (UUID) of the BLE transmitter, wherein the restricting the functionality of the application includes implementing a parental control restriction for the application, and wherein the method further includes:
associating the BLE transmitter with a child.

7. The method of claim 1, further including: if a first identifier is encoded in the wireless signal, the one or more operations include a first set of operations; and if a second identifier is encoded in the wireless signal, the one or more operations include a second set of operations.

8. The method of claim 1, further including:
associating the target distance with a first identifier;
receiving a second target distance;
associating the second target distance with a second identifier;
determining a second target wireless signal strength based on the second target distance;
wherein performing the one or more operations further includes performing the one or more operations if the wireless signal includes the first identifier; and
wherein if the wireless signal includes the second identifier then,
comparing the received wireless signal strength to the second target wireless signal strength; and
performing a second set of operations on the electronic device based on a result of the comparison between the received wireless signal strength and the second target wireless signal strength.

9. A non-transitory computer-readable storage medium containing instructions that, when executed by a processing subsystem in an electronic device, cause the electronic device to perform a method for proximity detection, the method comprising:
converting a target distance into a target wireless signal strength;
receiving, on the electronic device, a wireless signal;
generating a received wireless signal strength based on the received wireless signal;
comparing the received wireless signal strength to the target wireless signal strength; and
performing one or more operations on the electronic device based on a result of the comparison between the received wireless signal strength and the target wireless signal strength.

10. The non-transitory computer-readable storage medium of claim 9, wherein the wireless signal includes a Bluetooth low energy (BLE) protocol.

11. The non-transitory computer-readable storage medium of claim 9, wherein performing the one or more operations on the electronic device based on the results of the comparison between the received wireless signal strength and the target wireless signal strength further includes:
performing the one or more operations based on an identifier encoded in the wireless signal.

12. The non-transitory computer-readable storage medium of claim 9, further including:
converting a second target distance into a second target wireless signal strength;
comparing the received wireless signal strength to the second target wireless signal strength; and
performing a set of operations on the electronic device based on a result of the comparison between the received wireless signal strength and the second target wireless signal strength.

13. The non-transitory computer-readable storage medium of claim 9, wherein the one or more operations on the electronic device include:
restricting a functionality of an application operating on the electronic device.

14. The non-transitory computer-readable storage medium of claim 13, wherein the target distance is associated with a unique identifier of a Bluetooth low energy (BLE) transmitter, and the method further includes:
associating the BLE transmitter with a child, wherein restricting the functionality of the application includes implementing a parental control restriction for the application.

15. The non-transitory computer-readable storage medium of claim 9, further including:
if a first identifier is encoded in the wireless signal, the one or more operations include a first set of operations; and
if a second identifier is encoded in the wireless signal, the one or more operations include a second set of operations.

16. The non-transitory computer-readable storage medium of claim 9, further including:
associating the target distance with a first identifier;
associating a second target distance with a second identifier;
determining a second target wireless signal strength based on the second target distance;
wherein performing the one or more operations further includes performing the one or more operations if the wireless signal includes the first identifier; and
wherein if the wireless signal includes the second identifier then,
comparing the received wireless signal strength to the second target wireless signal strength; and
performing a second set of operations on the electronic device based on a result of the comparison between the received wireless signal strength and the second target wireless signal strength.

17. An apparatus that facilitates proximity detection, comprising:
a network subsystem, wherein the network subsystem is configured to receive a wireless signal; and
a processing subsystem coupled to the networking subsystem and configured to receive a signal from the network subsystem, wherein the processing subsystem is configured to:
convert a target distance into a target wireless signal strength;
generate a received wireless signal strength based on the received wireless signal;
compare the received wireless signal strength to the target wireless signal strength; and
perform one or more operations on the electronic device based on a result of the comparison between the received wireless signal strength and the target wireless signal strength.

18. The apparatus of claim 17, wherein the one or more operations include:
restricting a functionality of an application operating on the apparatus.

19. The apparatus of claim 18, wherein restricting the functionality of the application includes implementing a parental control on the application.

20. The apparatus of claim 17, wherein at least one of the processing subsystem and the networking subsystem are configured to decode an identifier encoded in the wireless signal, and the processing subsystem is further configured to:
receive a target identifier associated with the target distance; and
perform the one or more operations based on the relationship between the decoded identifier and the target identifier.

21. The apparatus of claim 17, wherein the wireless signal is encoded using encoded with a Bluetooth low energy (BLE) protocol.

22. A method for proximity detection performed at an electronic device, the method comprising:
the electronic device receiving a wireless signal from a second electronic device;
the electronic device determining, based on a strength of the wireless signal, whether the electronic device is within a target distance from the second electronic device; and
if the electronic device is within the target distance from the second electronic device, the electronic device performing one or more operations.

23. The method of claim 22, wherein the one or more operations include restricting a functionality of an application operating on the electronic device.

24. The method of claim 23, wherein the application is a telephony application and the restricting the functionality includes disabling one or more non-voice input modes for the application.

25. The method of claim 23, wherein the application is a text messaging application and the restricting the functionality includes inhibiting the text messaging application from generating an audible alert in response to receiving a message.

26. The method of claim 23, wherein the restricting the functionality of the application includes implementing a parental control restriction for the application.
